(19) United States
(12) Patent Application Publication
(10) Pub. No.: US 2005/0068470 A1
(43) Pub. Date: Mar. 31, 2005

(54) Liquid crystal display device

(76) Inventor: Se Chang Won, Pyeontgtaek-shi (KR)

Correspondence Address: MCKENNA LONG & ALDRIDGE LLP, 1900 K STREET, NW, WASHINGTON, DC, 20006, US

(21) Appl. No.: 10/878,386

(22) Filed: Jun. 29, 2004

(30) Foreign Application Priority Data
Sep. 30, 2003 (KR) P2003-67845

(51) Int. Cl. G02F 1/1335

(52) U.S. Cl. 349/58

(57) ABSTRACT

An LCD device is disclosed, in which a lamp housing is formed of a reflecting sheet instead of a metal material, to obtain the simplified manufacturing process and to decrease the manufacturing cost. The LCD device includes an LCD panel; a light-guiding plate below the LCD panel; a lamp at one side of the light-guiding plate; a first reflecting sheet below the lamp and the light-guiding plate; a support main corresponding to an outer side of the LCD panel to support the lamp, the first reflecting sheet and the LCD panel; a second reflecting sheet between the lamp and the support main; a case top covering the outer side of the LCD panel and the support main; and a cover bottom below the reflecting sheet to be coupled with the case top.

This application claims the benefit of the Korean Application No. P2003-67845, filed on Sep. 30, 2003, which is hereby incorporated by reference.

### BACKGROUND OF THE INVENTION

1. Field of the Invention

The present invention relates to a liquid crystal display (LCD) device, and more particularly, to a liquid crystal display (LCD) device having a reflecting plate which simplifies a manufacturing process and decreases manufacturing costs.

2. Discussion of the Related Art

Demands for various display devices have increased in our information society. Accordingly, many efforts have been directed towards the research and development of various flat display devices such as liquid crystal displays (LCD), plasma display panels (PDP), electroluminescent displays (ELD), and vacuum fluorescent displays (VFD). Some species of flat display devices have already been applied to displays for various equipment. Among the various flat display devices, liquid crystal display (LCD) devices have been most widely used due to advantageous characteristics of a thin profile, light weight, and low power consumption, such that the LCD devices provide a substitute for a Cathode Ray Tube (CRT). In addition to mobile type LCD devices such as a display for a notebook computer, LCD devices have been developed for computer monitors and televisions to receive and display broadcast signals. Despite various technical developments in LCD technology having applications in different fields, research relating to enhancing the picture quality of the LCD device has been, in some respects, lacking in comparison to research done for other features and advantages of an LCD device. In order to use LCD devices in various fields as a general display, the development of LCD devices depends on whether LCD devices can implement a high quality picture, such as high resolution and high luminance with a large-sized screen, while still maintaining light weight, a thin profile, and low power consumption.

The LCD device includes an LCD panel for displaying a picture image, and a driving part for applying a driving signal to the LCD panel. The LCD panel includes first and second glass substrates bonded to each other at a predetermined interval, and a liquid crystal layer injected between the first and second glass substrates.

More specifically, the first glass substrate (TFT array substrate) includes a plurality of gate and data lines, a plurality of pixel electrodes, and a plurality of thin film transistors. The plurality of gate lines are formed on the first glass substrate at fixed intervals in one direction, and the plurality of data lines are formed at fixed intervals perpendicular to the plurality of gate lines, thereby forming a plurality of pixel regions. Then, the plurality of pixel electrodes are formed as a matrix-type configuration in the respective pixel regions defined by the plurality of gate and data lines crossing each other. The plurality of thin film transistors are switched according to signals of the gate lines for transmitting signals of the data lines to the respective pixel electrodes. Next, the second glass substrate (color filter substrate) includes a black matrix layer shielding light from regions of the first substrate except the pixel regions, an R/G/B color filter layer displaying colors, and a common electrode complementing a picture image.

The LCD device is driven according to optical anisotropy and polarizing characteristics of the liquid crystal material. Liquid crystal molecules are aligned using directional characteristics because the liquid crystal molecules have long and thin shapes. An alignment direction of the liquid crystal molecules of the liquid crystal layer is controlled by an electric field induced thereto. Accordingly, light irradiated through the liquid crystal layer may be controlled by the alignment direction of the liquid crystal molecules, thereby displaying the image.

Hereinafter, an LCD device according to the related art will be described with reference to the accompanying drawings. FIG. 1 is a plane view illustrating an LCD device according to the related art. FIG. 2 is a cross-sectional view taken along line I-I′ of FIG. 1 in accordance with the related art.

As shown in FIG. 1 and FIG. 2, the LCD device according to the related art includes an LCM, a driving circuit part (not shown) for driving the LCM, and a case having a top cover 2 and a cover bottom 4. The LCM is comprised of an LCD panel 1, and a backlight unit for emitting light to the LCD panel 1. The LCD panel 1 includes upper and lower substrates 1a and 1b, a liquid crystal layer (not shown) between the upper and lower substrates 1a and 1b, and polarizing films 1c and 1d on rear sides of the upper and lower substrates 1a and 1b. Moreover, a plurality of optical sheets 7 and the backlight unit are positioned below the LCD panel 1. From the upper side, the optical sheets 7 are sequentially comprised of a protective sheet (not shown), a prism sheet 7a and a diffusion sheet 7b. In addition, the optical sheets may have additional sheets according to the desired function. Also, the backlight unit includes a lamp 6 corresponding to the outer side of the LCD panel 1, a lamp housing 9 surrounding the lamp 6, and a light-guiding plate 8 disposed at one side of the lamp 6 and the lamp housing 9. A reflecting plate 10 is formed under the light-guiding plate 8 to reflect light incident from the side, thereby improving luminous efficiency. A support main 3 is provided above the lamp 6 such that the support main 3 corresponds to the outer side of the LCD panel 1. The support main 3 supports the LCD panel 1 and the backlight unit. The top case 2 is bent in an outer side of the LCD panel 1 to surround the support main 3, and the cover bottom 4 is coupled with the top case 2.

The upper and lower glass substrates 1a and 1b may be damaged by external impacts thereby damaging the LCM. Accordingly, in order to prevent damage to the LCM, the top case 2 and the bottom cover 4 cover the exterior of the LCM. Also, the support main 3, which is made of plastic material, is connected with the cover bottom 4 thereby covering the outer side of the LCM. The support main 3 has a step shape formed therein. The sheets 7, which may include upper/lower diffusion sheets and upper/lower prism sheets, is disposed below the LCD panel 1. The lamp 6 and the lamp housing 9 which surrounds the lamp 6 are also below the sheets 7. Additionally, as may be seen with reference to FIG. 2, the lamp housing 9 surrounds a portion of both the light-guiding plate 8 and the reflecting plate 10, where both the light-guiding plate 8 and the reflecting plate 10 are provided at one side of the lamp 6. Furthermore, the light-guiding plate 8 and the reflecting plate 10 are provided below the sheets 7. The lamp housing 9, which is made of a metal material, is solidified inside the support main 3 to protect the lamp 6. The lamp housing 9 is manufactured with an additional mold according to the model of the LCD device. Also, the lamp 6 is driven by an inverter part (not shown) of the driving circuit part (not shown), and a power voltage is provided to the lamp 6 through an external plug 15. Although not shown, the driving circuit part is provided on a PCB (Printed Circuit Board) substrate, in order to drive the LCD panel 1. A TCP (Tape Carrier Package) is used for transmission of signals between the LCD panel 1 and the PCB substrate. The TCP is directly bonded to the lower glass substrate 1b of the LCD panel 1 and the PCB substrate by using conductive resin. The TCP has the structure of flexible layers interposed with one conductive metal layer or more.

However, the LCD device according to the related art has the following disadvantages. First, since the lamp housing is formed of a metal material, an additional mold for the lamp housing is required, thereby increasing the manufacturing cost. Also, it is impossible to change the size of the lamp housing after manufacturing the mold for the lamp housing having a predetermined size. Furthermore, the metal material increases manufacturing costs.

### SUMMARY OF THE INVENTION

Accordingly, the present invention is directed to an LCD device that substantially obviates one or more problems due to limitations and disadvantages of the related art.

An object of the present invention is to provide an LCD device where a lamp housing is formed of a reflecting sheet instead of a metal material thereby simplifying manufacturing processes and decreasing manufacturing costs.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with an embodiment of the present invention, as embodied and broadly described herein, a liquid crystal display (LCD) device includes an LCD panel; a light-guiding plate below the LCD panel; a lamp at one side of the light-guiding plate; and a first reflecting sheet below the lamp and the light-guiding plate. The LCD device also includes a support main corresponding to an outer side of the LCD panel to support the lamp, the first reflecting sheet and the LCD panel; a second reflecting sheet between the lamp and the support main. In addition, the LCD device has a case top covering the outer side of the LCD panel and the support main; and a cover bottom below the reflecting sheet which couples with the case top.

The second reflecting sheet is formed on an inner surface of the support main adjacent to the lamp.

Also, the inner surface of the support main is formed in a shape of ‘ [symbol] ’, and the second reflecting sheet is adhered to the inner surface of the support main.

Also, the second reflecting sheet is formed of the same material as the first reflecting sheet.

Furthermore, the LCD device includes diffusion, prism and protection sheets between the light-guiding plate and the LCD panel.

Also, a lower substrate of the LCD panel has a margin as compared with an upper substrate of the LCD panel.

The support main and the lamp correspond to non-pixel regions of the LCD panel.

Also, the second reflecting sheet adheres to the inner surface of the support main with an adhesive.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a plane view illustrating a related art LCD device;

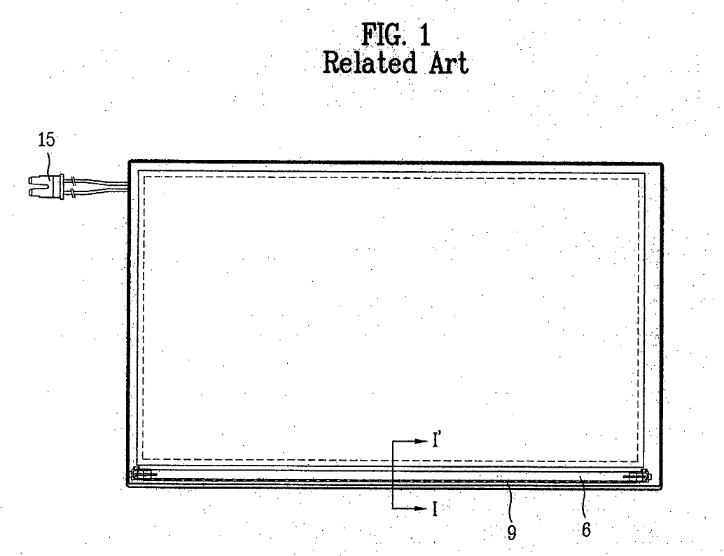

FIG. 2 is a cross-sectional view taken along line I-I′ of FIG. 1 in accordance with the related art;

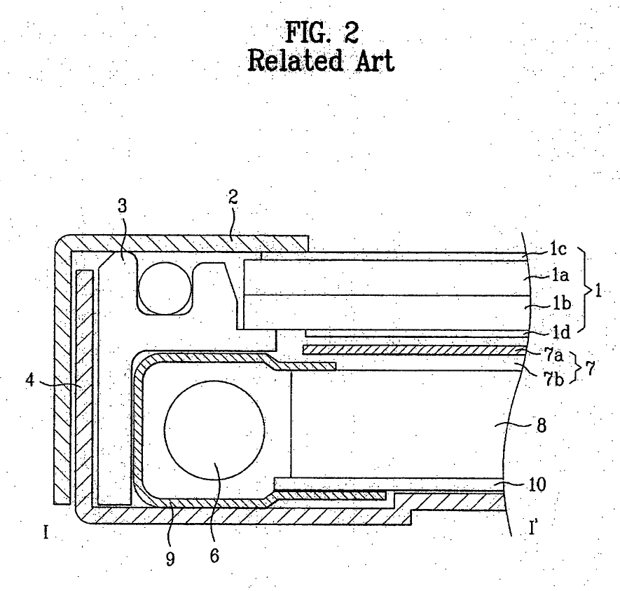

FIG. 3 is a plane view illustrating an LCD device according to an embodiment of the present invention; and

FIG. 4 is a cross-sectional view taken along line II-II′ of FIG. 3 in accordance with an embodiment of the present invention.

### DETAILED DESCRIPTION OF THE INVENTION

Reference will now be made in detail to embodiments of the present invention, examples of which are illustrated in the accompanying drawings. Wherever possible, the same reference numbers will be used throughout the drawings to refer to the same or like parts.

Hereinafter, an LCD device according to the present invention will be described with reference to the accompanying drawings. The LCD device according to the present invention is used in small applications, wherein a reflecting sheet is formed between a lamp and a support main instead of using a lamp housing of a metal material.

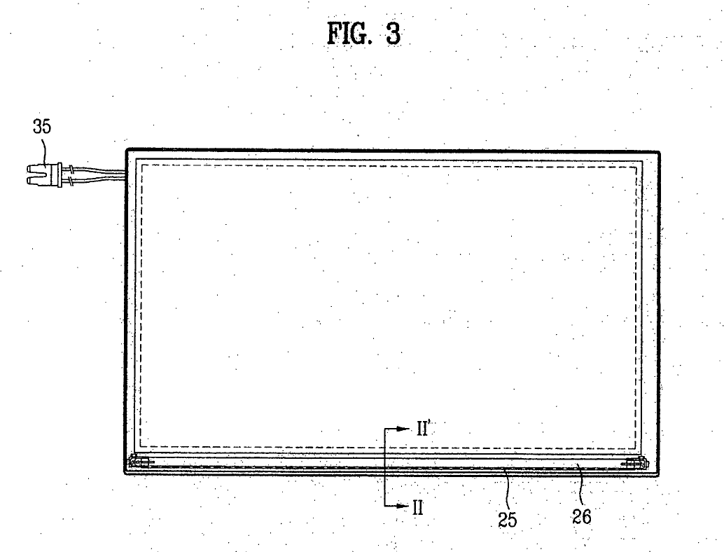

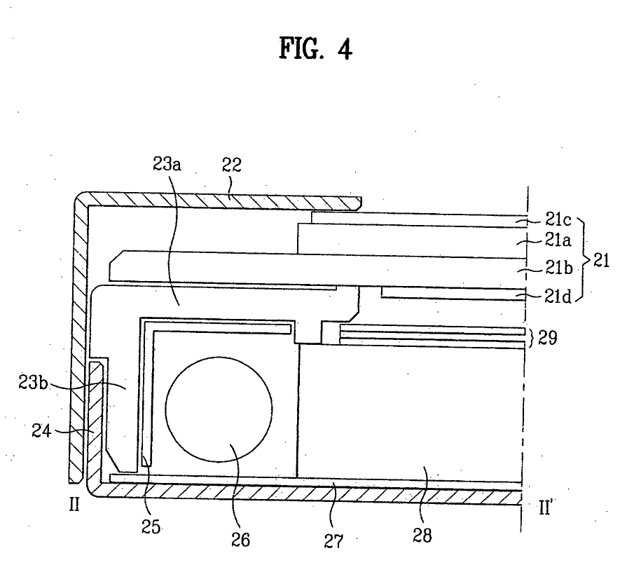

FIG. 3 is a plane view illustrating an LCD device according to the present invention. FIG. 4 is a cross-sectional view taken along line II-II′ of FIG. 3. As shown in FIG. 3 and FIG. 4, the LCD device according to the present invention includes an LCD panel 21, a light-guiding plate 28, a lamp 26, a first reflecting sheet 27, a support main 23, a second reflecting sheet 25, a case top 22, and a cover bottom 24. In this embodiment, the light-guiding plate 28 is provided below the LCD panel 21, and the lamp 26 is provided at one side of the light-guiding plate 28. Also, the first reflecting sheet 27 is provided below both the lamp 26 and the light-guiding plate 28. The support main 23 corresponds with an outer side of the LCD panel 21 to support the lamp 26, the light-guiding plate 28, the first reflecting sheet 27 and the LCD panel 21. The second reflecting sheet 25 is provided on an inner wall of the support main 23 to surround the lamp 26. The case top 22 covers the outer side of the LCD panel 21 and the support main 23, and the cover bottom 24 is provided under the first reflecting sheet 27 and couples with the case top 22 such that the support main 23 is disposed between the case top 22 and the cover bottom 24. In this embodiment, the second reflecting sheet 25 serves as a lamp housing.

The LCD panel 21 includes a lower substrate 21b forming a TFT array of a matrix-type configuration, an upper substrate 21a forming a color filter array corresponding to the TFT array, and a liquid crystal layer (not shown) between the two substrates 21a and 21b. Also, polarizing films 21c and 21d are respectively formed on rear sides of the upper and lower substrates 21a and 21b. The second reflecting sheet 25 may function as a lamp housing surrounding the lamp 26, and is provided adjacent to the inner surface of the support main 23. In this embodiment, the second reflecting sheet 25 adheres to the inner surface of the support main 23 corresponding to the lamp 26 by an adhesive. The inner surface of the support main 23 adjacent to the lamp 26 is formed in a shape of ‘ [symbol] ’, and adheres to the second reflecting sheet 25. To further illustrate, in one embodiment, the support main 23 includes a first section 23a and a second section 23b where the first section 23a and the second section 23b are formed at right angles to one another as shown in FIG. 4. Furthermore, in this embodiment, the second reflecting sheet 25 is disposed adjacent the first section 23a and the second section 23b, as may also be seen with reference to the Figure. Also, the second reflecting sheet 25 is formed of the same sheet as the first reflecting sheet 27. Accordingly, it is possible to decrease the burden on a mold in the LCD device according to the present invention as compared with the related art LCD device forming the lamp housing of the metal material. Furthermore, it is possible to change the second reflecting sheet 25 slightly after formation.

Also, the plurality of sheets 29 of diffusion, prism and protection sheets are formed on the light-guiding plate 28. Unlike the upper substrate 21a of the LCD panel 21, the lower substrate 21b of the LCD panel 21 has a margin for a driving circuit part. In this embodiment, the support main 23 and the lamp 26 correspond to non-pixel regions of the LCD panel 21 (the outside of a dotted rectangle). Also, the lamp 26 is driven by an inverter (not shown) of the driving circuit part (not shown), and a power voltage is provided to the lamp 26 through an external plug 35.

Accordingly, the LCD device according to the present invention has the following advantages.

First, the support main surrounds the lamp, and the second reflecting sheet is provided adjacent to the inner surface of the support main, whereby it is not required to provide the lamp housing of the metal material. That is, the support main and the reflecting sheet serve as the lamp housing. Also, the present invention reduces costs associated with manufacturing since the present invention does not require metal material for the lamp housing. In addition, the reflecting sheet may function as the lamp housing, thereby enhancing the ability to change the lamp housing after manufacturing the LCD device.

It will be apparent to those skilled in the art that various modifications and variations can be made in the present invention. Thus, it is intended that the present invention covers the modifications and variations of this invention provided they come within the scope of the appended claims and their equivalents.

1. A liquid crystal display (LCD) device comprising:
an LCD panel;
a light-guiding plate below the LCD panel;
a lamp at one side of the light-guiding plate;
a first reflecting sheet below the lamp and the light-guiding plate;
a support main corresponding to an outer side of the LCD panel to support the lamp, the first reflecting sheet and the LCD panel;
a second reflecting sheet between the lamp and the support main;
a case top covering the outer side of the LCD panel and the support main; and
a cover bottom below the first and second reflecting sheets to be coupled with the case top.

2. The LCD device of claim 1, wherein the second reflecting sheet is formed on an inner surface of the support main adjacent to the lamp.

3. The LCD device of claim 1, wherein an inner surface of the support main is formed in a shape of ‘ [symbol] ’, and the second reflecting sheet adheres to the inner surface of the support main.

4. The LCD device of claim 1, wherein the second reflecting sheet is formed of the same material as the first reflecting sheet.

5. The LCD device of claim 1, further comprising diffusion, prism and protection sheets between the light-guiding plate and the LCD panel.

6. The LCD device of claim 1, wherein a lower substrate of the LCD panel has a margin as compared with an upper substrate of the LCD panel.

7. The LCD device of claim 1, wherein the support main and the lamp correspond to non-pixel regions of the LCD panel.

8. The LCD device of claim 1, wherein the second reflecting sheet adheres to the inner surface of the support main by an adhesive.

9. A liquid crystal display (LCD) device comprising:
an LCD panel having an outer side;
a light guiding plate disposed below the LCD panel;
a lamp adjacent the light guiding plate;
a first reflecting sheet disposed below the lamp and the light guiding plate;
a support main corresponding to the outer side of the LCD panel, the support main supporting the lamp, the first reflecting sheet and the LCD panel;
a lamp housing surrounding the lamp where the lamp housing is a second reflecting sheet;
a case top which covers the outer side of the LCD panel and the support main; and
a cover bottom below the first and second reflecting sheets, the cover bottom coupling with the case top.

10. The LCD device of claim 9, wherein the second reflecting sheet is formed in an inner surface of the support main such that the second reflecting sheet is adjacent the lamp.

11. The LCD device of claim 9,. wherein the support main further comprises:
a first section; and
a second section where the first section and the second section are formed at right angles to one another wherein the second reflecting sheet adheres to both the first section and the second section with an adhesive.

12. The LCD device of claim 9, wherein the first reflecting sheet and the second reflecting sheet are formed from a same material.

13. The LCD device of claim 9, wherein the LCD panel further comprises:
an upper substrate; and
a lower substrate where the lower substrate includes a margin.

14. The LCD device of claim 9, wherein the support main and the lamp correspond to non-pixel regions of the LCD panel.
